(19) United States
(12) Patent Application Publication
(10) Pub. No.: US 2012/0100319 A1
(43) Pub. Date: Apr. 26, 2012

(54) INSULATION OF A VENTILATION DUCT AGAINST A WALL/CEILING PENETRATION

(75) Inventors: Horst Keller, Wilhelmsfeld (DE); Andreas Köhler, Mannheim (DE); Torsten Wahls, Lubz (DE); Leif Andersson, Eslov (SE); Hans-Jörg Frantz, Birkenau (DE); Michael Schumm, Schriesheim (DE)

(73) Assignee: SAINT-GOBAIN ISOVER, Courbevoie (FR)

(21) Appl. No.: 12/672,288

(22) PCT Filed: Aug. 1, 2008
(86) PCT No.: PCT/EP2008/006377

§ 371 Date: Sep. 12, 2011

(30) Foreign Application Priority Data
Aug. 8, 2007 (DE) 10 2007 037 243.6

(51) Int. Cl. B32B 1/08

(52) U.S. Cl. 428/34.5; 428/34.1; 428/34.6

(57) ABSTRACT

The invention concerns the insulation of a duct 2, especially an air-conditioning or ventilation duct, which passes through a penetration in a wall 1 or ceiling or the like, and an insulating material 3 is provided all around the outside of the duct 2. In this regard, the insulating material 3 has an end face pointing at least partly in the direction of the penetration. Sections of the end face, at least, are provided with heat-resistant adhesive material 11.

The present invention relates to the insulation of a duct, especially an air-conditioning or ventilation duct, in accordance with the generic term of claim 1.

Ventilation ducts are needed in buildings to supply fresh air to rooms and to connect them, e.g., to a centralized air-conditioning system. The ducts are passed through penetrations in the walls and/or ceilings of the rooms. Relevant fire safety standards stipulate that, in the event of a fire, it or its smoke may not spread from one building area to another, or if so only after a delay. For this reason, the wall or ceiling penetration has to be sealed to prevent the fire from spreading. In this regard, it must be borne in mind that the fire and its smoke may spread either through the ventilation duct itself, or through the building gap between the outside of the duct and the opening of the penetration in the wall.

For these reasons, for one thing, the outside of the duct is sheathed on all sides with a continuous layer of insulation material, which, for example, is rock wool, to delay an increase in surface temperature of an insulated section of the duct which is not affected by fire.

Furthermore, the wall penetration is sealed. This is done with packing material, which packs the gap between the wall and the duct and goes as closely as possible into the insulation material around the duct. Since this structure is still inadequate for providing insulation, it is usual to provide a collar of insulation material which is outside the insulation described above and is in direct contact with the wall/ceiling. Tests have shown that, while this collar is good at sealing the wall penetration, the temperature profile at the duct is influenced in such a way that elevated temperatures may occur at the transition from the collar to the described duct insulation. Furthermore, fitting of the collar entails a costly extra working step.

The object of the present invention is to insulate a duct in the area of a wall penetration against temperature increases in a structurally simple and reliable way such that the conditions of the relevant fire safety standards are met. At the same time, a high fire resistance duration is to be achieved and a seal provided against leakage of gases. Furthermore, the solution is to be inexpensive and easy to process.

This object is achieved in accordance with the inventive characteristics of claim 1.

According to the invention, a duct, especially an air-conditioning or ventilation duct, which is passed through a penetration in a wall or ceiling or the like, is insulated such that it complies with corresponding fire resistance standards, such as the provisions of the fire resistance standard DIN 4102-6, especially L 30 to L 120, depending on the design, that is, a fire rating of 30 min, 60 min, 90 min, or 120 min. In this connection, the outside of the duct is wrapped all around with insulation material that has an end face which points at least partly in the direction of the penetration and at which a heat-resistant adhesive material is provided. The insulation material is preferably made of mineral wool.

The insulation is needed to hinder or delay a fire, which has broken out in a first room, from spreading to a second, adjacent room, there being provided between the two rooms a wall penetration, through which the aforementioned duct passes. Similarly, the penetration may be in a ceiling or roof or the like, but for the sake of simplicity hereafter reference will be primarily to a wall penetration, which shall also be construed as including the other types. The fire resistance standards are DIN 4102-6 and the equivalent EN 1366 T1.

An example of suitable insulating material is mineral wool, especially a mineral wool of the kind known from EP 1522800 A1. The use of these insulating materials for the inventive insulating device is particularly advantageous and is a further inventive aspect. This wool typically comprises a plurality of thin fibres made from a heat-resistant material and preferably has a melting point determined in accordance with DIN 4102 Part 17 of at least 1000° C. However, in addition to these insulation materials, traditional mineral wools, such as rock wool, or as necessary, glass wool, are eligible. In general, any material is conceivably eligible that offers adequate heat resistance and is fibrous.

Since, in accordance with the invention, the end face, which points towards the wall penetration, is provided with an adhesive material, the individual fibres here are bonded. In other words, the adhesive material is located between the individual fibres at the end face. Now, if the end face of the insulation material is in contact with the wall and gases are threatening to come from the burning room via the wall penetration, i.e. the gap between the duct and wall into the adjacent room, the increase in density at the end face that is due to the adhesive material ensures that ingress into the adjacent room is impeded. The only possibility is for the gases to force their way into an area between the duct and the insulation material. However, because this gap, if any, is very narrow, ingress is hindered for one thing and, for another, it is of limited harm at this transition area since it still has to pass through the insulation material before it can reach the adjacent room. As a result, the ingress of gases can be correspondingly delayed in time and reduced in quantity, such that corresponding fire resistance standards are complied with.

In an advantageous embodiment, the insulation material is bonded to the wall, as a result of which the end face of the insulating material is securely connected to the wall. A fire rating of 60-90 min in accordance with EN1366 T1 requires, for example, that the insulation material around the duct be up to 90 mm thick. The size of the gap between the wall penetration and the duct is usually 50 mm on all sides, with this gap width needed during assembly for the installation of the duct with the attached connecting elements. The difference between the two is an overlapping width of 40 mm, in which the insulating material is bonded to the wall. Penetrating gases are therefore unable to gain ingress into the adjacent room. The bond is designed to have a high lifetime even at elevated temperatures.

When the insulation is being assembled, care is taken to ensure that the insulating material presses elastically against the wall on all sides. However, if the insulation material is heated by hot gases or fire, its property changes and it may soften and deform. While traditionally this may have created a gap between wall and insulating material, the bond ensures that the connection between wall and insulating remains permanent, even at high temperatures.

The gap between duct and wall and is usually packed with a packing material. This packing material affords good insulating properties at high temperatures, too, and can be the same material as the insulation material surrounding the duct. The packing material can comprise one or more strips or panels of insulating material, which is laid or packed into the gap, or an unstructured, wool-like substance may be used. Advantageously, the end face of the insulating material is bonded to this packing material. The outcome is a continuous sheath of insulating material around the duct, and the spread of fire and smoke into the room is hampered.

The insulation material need not be directly bonded to the wall, but rather it is also conceivable for further structural elements, such as profiles, panels, and the like, to which the insulation material is bonded, to be permanently attached to the wall.

The insulating properties of the packing material are enhanced by advantageously furnishing it with a foam-forming agent. A foam-forming agent comprises substances which, when heated, release foam that inhibits the fire and so reduces or delays the spread of flames.

Advantageously, the packing material is packed in the aforementioned gap in a first working step, and then its two end faces pointing in the direction of the wall are provided with the foam-forming agent. After the foam-forming agent has hardened/dried, the packing material, whose surface has thus been modified, is used for bonding the insulation material here. The foam-forming agent effectively limits and delays the spread of fire.

The aforementioned adhesive material is preferably a silicate-based adhesive. Such adhesive materials have the advantage of being easy to process, that is, without much effort—such as by brushing—onto the insulating material. It is also possible to first provide the wall or the packing material with the adhesive, and then to connect it to the insulation material, which is possibly also provided with adhesive.

Advantageously, the described insulation is used in ducts which have an oblong, particularly square cross-section. Since the duct is surrounded by panels of the insulation material, appropriately cut-to-size panels can be easily placed on them and attached to the duct with pins or bolts.

Profile elements can be attached to the duct in the area of the penetration. Since, high temperatures occur in a fire, thermal expansion and stresses also occur on the duct itself, which can consist of thin sheet metal. As described, the packing material is located outside the duct in the wall penetration, as a result of which the duct cannot bulge outwardly. Instead, it might bulge inwardly at these points. Looking axially at the penetration, this would produce an extended gap, through which the fire or the gases could gain ingress. To reduce or avoid these adverse effects, a profile element, such as an angle shape, may be mounted to the duct, possibly by riveting. The angle shape could advantageously be a profile 3 mm+/−1 mm thick, and have flanks 20 mm to 40 mm long. U-shaped profiles or rectangular shapes are also conceivable.

Advantageously, one angle shape is attached by one of its flanks to each side of the duct. The longitudinal direction of the shapes is in the plane of the wall. Overlapping of the shape to the wall is achieved by having at least one of the shapes longer than the size of the wall penetration. Thus, the shape can be mounted to the wall by, for example, bolts. These mounts enable the duct to be adjusted relative to the penetration. Thus, the duct is kept stably in position such that no change in gap width can occur that would impair the sealing effect across the penetration.

Preferred embodiments of the present invention are explained below with the aid of drawings. They show in

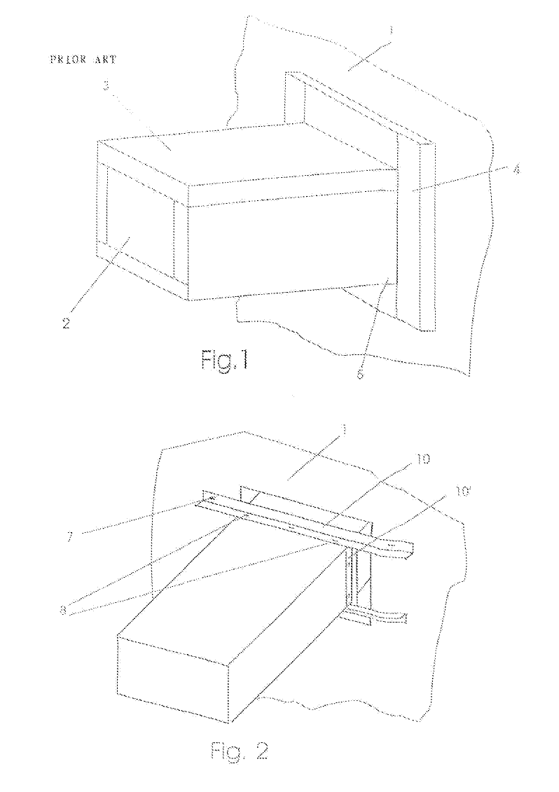

FIG. 1: a ventilation duct with wall penetration in accordance with the prior art,

FIG. 2: a view of the duct and wall penetration before assembly of the insulation material,

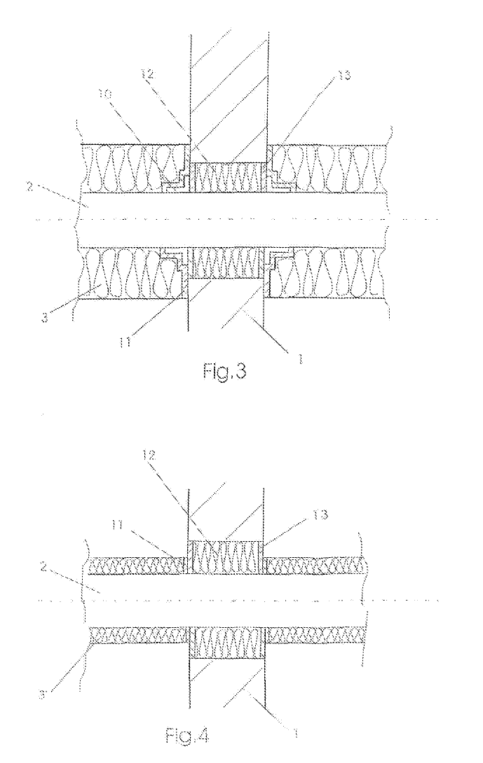

FIG. 3: an inventive insulation, in which the gap between duct and penetration is smaller than the thickness of the insulation material and

FIG. 4: an inventive insulation, in which the gap between duct and penetration is greater than the thickness of the insulation material

FIG. 1 shows the passage of a duct 2 through a wall 1 in the embodiment of the prior art. The duct is surrounded on all four sides with insulation material 3. At the transition from insulation material 3 to the wall 1 is arranged a collar chuck (4), which is made from insulation material and which seals the wall penetration against the flames/gases. The collar is attached to the wall 1 with special nails or dowels (not shown) and presses against the insulation material 3. The insulation material is predominantly rock wool. The collar 4 can influence the temperatures at the measuring points in accordance with EN 1366 Part 1, a fact which can impact the fire resistance duration.

FIG. 3 and FIG. 4 show a cross-section through a wall 1 of two embodiments of the inventive insulation.

FIG. 3 shows an embodiment with insulation material 3 in a thickness of 90 mm. For a fire rating of 60-120 min in accordance with EN 1366 Part 1, a thickness of 30-90 mm is used. The gap between duct and wall penetration, in which is located the packing material 12, has a thickness, for example, of 50 mm. If, for example, the duct is 300 mm high, the height of the wall penetration is chosen by the client to be 400 mm, such that the duct, with the mounting elements provided thereon (such as end-face flange, not shown), can be readily installed. After installation of the duct, there is an all-round gap of some 50 mm between the duct and the wall penetration. This gap is traditionally filled with packing material 12 made from mineral wool, with preference given to dense packing in order to achieve a good seal against gases and fire in the event of fire. A layer of fire retardant material, especially a foam-forming agent 13, is provided at both end faces of the packing material. Such fire-retardant foam-forming agents are commercially available. Adjacent these are located angle profiles 10, which make contact with duct 2 and are attached to it via rivets 8 (FIG. 2) in the conventional manner.

As shown in the cross-section of FIG. 3, the insulation material made from mineral wool 3 sheaths the duct 2. A layer 11 of adhesive material is provided at the end faces of insulating material pointing to the wall 1. This layer 11 is divided into three sections. In an outer section (i.e. away from the centre of the duct), the insulation material 3 is bonded to the wall 1. In a central section, the adhesive material 11 bonds the insulating material 3 to the packing material 12 coated with the foam-forming agent 13. In an inner section, the insulation material is bonded to the angle shapes 10.

In the illustrations of FIGS. 3 and 4, the layers of the foam-forming agent 13 and adhesive material 11 are shown disproportionately large for the sake of clarity.

The insulating effect works as follows: First, a fire is conceivable in which the fire and/or hot gases spreads out inside the duct 2. In this case, the insulation material 3 arranged around the duct 2 works by delaying heat transfer into the interior of the room. The maximum permissible surface temperature of the insulation material, as defined in standards, is, for example, 180° C., such that its thickness has to be chosen accordingly and also in relation to the required fire resistance period.

It is also possible for the fire to spread outside the duct, i.e. via the gap between the duct and the wall penetration. If it is assumed that the fire has broken out on the right side of the wall 1 shown in FIG. 3, it can be assumed that the insulation material 3, which is located to the right of the wall, is destroyed relatively quickly. Subsequently, the foam-forming agent 13 shown on the right side of the wall delays the flames from spreading into the room shown on the left. Further, fire and smoke must penetrate through the packing material 12, where it impinges on the second layer of the film-foam-forming agent 13. To an extent depending on the intensity of the fire, these means naturally do not constitute an absolute barrier, but rather serve to produce a desired time delay in the spread. If the fire has penetrated this second layer of the foam-forming agent 13, it impinges on the adhesive material 11 provided on insulation material 3, the two main functions of said adhesive material 11 being as follows: First, the adhesive material 11 bonds the fibres of the insulation material 13, and thereby raises the density of the end face of the material. As a result, penetration of the insulation material by the flames and/or smoke is impeded. Since the adhesive material 11, as already described, comprises heat-resistant materials, such as silicate adhesives, it has a high heat resistance, and so also hinders flame spread. Furthermore, the adhesive material 11 connects the insulation material 3 to wall 1. Without this bond, the fire would carve out a gap and penetrate into the room. Since this possibility does not exist on account of the bond, the fire can only penetrate in the area between duct and insulating material. Since the fire, before it reaches the interior of the room, still has to overcome the thickness of the insulation material, which in this example is 90 mm, flame spread is effectively hampered, a fact which leads to wide ranges for the fire rating. Thus, corresponding fire resistance standards, especially the fire ratings EI 60, EI 90 and EI 120, can be met simply.

FIG. 4 shows an alternative embodiment, in which the duct 2 is sheathed with a much thinner layer of the insulation material 3′. This thinner insulating layer 30-35 mm thick is used in application areas where a fire rating of 15-30 min is required. In this case, the profile elements 10 are not needed because deformation of the duct 2 does not exert a significant influence on the failure of the insulation. As with the case FIG. 3, here, again, the gap between wall and duct 2 is filled with mineral wool packing material 12, whose end face is also provided with corresponding foam-forming agent 13. The insulation material 2 is bonded to the packing material 12, which is provided with foam-forming agent, by means of adhesive material 11.

The application case shown in FIG. 4 resembles that of FIG. 3. However, the end face of insulating material 2 is bonded exclusively to the packing material 12 coated with foam-forming agent 13. If, in the event of a fire, the fire overcomes the wall penetration between the duct 2 and the packing material 12, it cannot immediately gain ingress to the inside of the adjacent room, but rather will spread further between the insulation material 3′ and the duct. This will also hamper flame spread accordingly.

Although not required for the attainment of fire rating EI 15 or EI 3, angle shapes for increasing the rigidity and facilitating assembly can be provided in the case of embodiments of FIG. 4.

FIG. 2 shows the angle shapes 10 and 10′ for improving the dimensional rigidity of the duct. Thus, FIG. 2 shows two angle shapes 10, which are mounted to the duct 2 by means of three mounting points 8. Similarly, angles 10′ are mounted to the sides of the duct. Without these angles, the metal of the duct might twist or bulge inwardly, which would create a gap between packing material 12 and insulating material 3 to the metal of the duct, through which the fire and smoke could spread. To avoid this, the rigidity of the duct in this area is increased by the angles. Riveting and bolting are ideal means of mounting at the mounting points 8. Furthermore, the angle shapes 10 are attached to the wall 1 by a wall mounting 7, such as a bolted connection. As a result, the position of the duct itself relative to the wall penetration is secured. On the long sides of the duct 2 are shown two profiles 10 and also two further angle shapes 10′ at the transverse sides, which are shorter and not mounted to the wall 1. If the arrangement in FIG. 2 is sheathed with insulating material 3 and provided with packing material 12, the result is the embodiment shown in FIG. 3.

Suitable material for the duct is sheet metal, particularly sheet steel, which can be galvanized against corrosion. The thickness should not be less than 0.5 mm or more than 2 mm, with a thickness between 0.7 and 1.2 mm being advantageous. The aforementioned angle shape can be a steel profile 3 mm thick, with a flank length of 20 or 30 mm.

1. Device for the purpose of insulating a duct (2), especially an air-conditioning or ventilation duct passing through a penetration in a wall (1) or ceiling or the like, and a gap between duct (2) and penetration is filled with packing material (12) and wherein insulation material (3) is provided around the outside of the duct (2), and the insulating material (3) makes at least partial contact with the penetration via its end face, and a heat-resistant adhesive material (11) is provided over the end face of the insulating material, preferably over the full surface in some sections,
characterised by the fact that
the packing material (12) at an end pointing to the adhesive material (11) is coated with a fire-inhibiting foam-forming agent (13) and
that the heat-resistant adhesive material (11) bonds at least part of the surface of the insulating material (3) to the packing material coated with the foam-forming agent.

2. Device in accordance with claim 1,
characterised by the fact that
the heat-resistant adhesive material (11) bonds at least part of the surface of the insulating material (3), preferably the full surface, to angle elements (10 or 10′), especially L-sections, which, in the vicinity of the penetration, are mounted to the duct (2) and/or to the wall or ceiling (1) or the like surrounding the penetration.

3. Device in accordance with claim 1,
characterised by the fact that
the heat-resistant adhesive material (11) bonds at least part of the surface of the insulating material (3), preferably the full surface, to the wall or ceiling (1).

4. Device for the purpose of insulation in accordance with claim 1,
characterised by the fact that
the heat-resistant adhesive material (11) is a silicate adhesive, especially an adhesive based on waterglass.

5. Device for the purpose of insulation in accordance with claim 1,
characterised by the fact that
the duct (2) is rectangular.

6. Device for the purpose of insulation in accordance with claim 1,
characterised by the fact that
the thickness of the insulating material (3) is greater than the gap (12) and the adhesive material (11) bonds the insulating material (3) both to the packing material (12) and to the wall or ceiling (1).

7. Device in accordance with claim 1,
characterised by the fact that
the insulating material (3) and the packing material (12) are formed by mineral wool.

8. Device in accordance with claim 7,
characterised by the fact that
the insulating material (3) and the packing material (12) are formed from rock wool.

9. Device in accordance with claim 7,
characterised by the fact that
the insulating material (3) and the packing material (12) are formed from material wool of the following composition:

| | | | |
|---|---|---|---|
| SiO₂ | 39-55% | preferably | 40-52% |
| Al₂O₃ | 16-27% | preferably | 16-26% |
| CaO | 9.5-20% | preferably | 10-18% |
| MgO | 1-5% | preferably | 1-4.9% |
| Na₂O | 0-15% | preferably | 2-12% |
| K₂O | 0-15% | preferably | 2-12% |
| R₂O (Na₂O + K₂O) | 10-14.7% | preferably | 10-13.5% |
| P₂O₅ | 0-3% | especially | 0-2% |
| Fe₂O₃ (iron, total) | 1.5-15% | especially | 3.2-8% |
| B₂O₃ | 0-2% | preferably | 0-1% |
| TiO₂ | 0-2% | preferably | 0.4-1% |
| Other | 0-2.0% | | |

wherein especially the composition of the mineral fibres of the insulating element (4) has an alkali/alkaline earth mass ratio of <1, and that the fibre structure of the insulating element (4) is determined by a mean geometrical fibre diameter ≦4 μm, a gross density in the range of 20 to 120 kg/m³ and a binder content, expressed in terms of the fibre mass of the insulating element (4), in the range 4 to 7 wt. % in the form of a panel or 0.5 to 1 wt. % in the form of a wire mesh mat.
